(19) United States
(12) Patent Application Publication
(10) Pub. No.: US 2008/0190028 A1
(43) Pub. Date: Aug. 14, 2008

(54) Compact Cable Drive Power Sliding Door Mechanism

(76) Inventor: Peter Lance Oxley, Mount Albert (CA)

Correspondence Address: MAGNA INTERNATIONAL, INC., 337 MAGNA DRIVE, AURORA, ON, L4G-7K1, omitted

(21) Appl. No.: 11/815,904

(22) PCT Filed: Feb. 20, 2006
(86) PCT No.: PCT/CA06/00254

§ 371 Date: Aug. 9, 2007

Related U.S. Application Data
(60) Provisional application No. 60/654,401, filed on Feb. 18, 2005.

(51) Int. Cl. E05F 15/14; B60J 5/06

(52) U.S. Cl. 49/360

(57) ABSTRACT

A sliding door drive assembly is used with a motor vehicle having an electric energy source and a sliding door. The sliding door drive assembly includes a motor that is electrically connected to the electric energy source. The motor converts electric energy into a rotating force. The sliding door drive assembly also includes a transmission that is operatively connected to the motor for transmitting the rotating force to an output shaft. A cable drum is fixedly secured to the output shaft and rotates with the output shaft. First and second cables are wound about the cable drum in opposite directions. The first cable extends from the cable drum forward along a path to the sliding door. The second cable extends from the cable drum rearward along the path toward the sliding door. The sliding door drive assembly also includes support guides extending tangentially out from the cable drum to guide the first and second cables outwardly and away from the cable drum along a path minimizing frictional forces.

### FIELD OF THE INVENTION

The invention relates to a motor vehicle sliding doors. More specifically, the invention relates to a drive assembly for automatically moving a sliding door between a fully open position and a fully close position.

### DESCRIPTION OF THE RELATED ART

In motor vehicles having sliding doors, the sliding doors are operated either manually or automatically. When there is a power opening mechanism for the sliding door, the power opening mechanism works electronically by activating a switch within the motor vehicle or by activating a remote, typically located on a key fob. These power opening mechanisms for opening sliding doors are becoming more and more popular. Although having the ability to press a button and open a sliding door is convenient, there are certain disadvantages.

Specifically, drive assemblies for these power opening mechanisms are heavy, which adds weight to the motor vehicle. Another problem associated with the power opening mechanisms is that manual operation of the sliding door becomes much more difficult due to the fact that a certain amount of force must be exerted on the sliding door to move the sliding door and rotate the motor to which the sliding door is attached. The inertia from the motor is typically higher than what is desired. Yet another common problem associated with such power opening mechanisms is the inability to adequately control the sliding door when anti-pinch systems are in place. While the anti-pinch systems work, the pinching force is greater than what would be desired.

### SUMMARY OF THE INVENTION

According to one aspect of the invention, a sliding door drive assembly is used with a motor vehicle having an electric energy source and a sliding door. The sliding door drive assembly includes a motor that is electrically connected to the electric energy source. The motor converts electric energy into a rotating force. The sliding door drive assembly also includes a transmission that is operatively connected to the motor for transmitting the rotating force to an output shaft. A cable drum is fixedly secured to the output shaft and rotates with the output shaft. First and second cables are wound about the cable drum in opposite directions. The first cable extends from the cable drum forward along a path to the sliding door. The second cable extends from the cable drum rearward along the path toward the sliding door. The sliding door drive assembly also includes support guides extending tangentially out from the cable drum to guide the first and second cables outwardly and away from the cable drum along a path minimizing frictional forces.

According to another aspect of the invention, a sliding door drive assembly is used with a motor vehicle having an electric energy source and a sliding door. The sliding door drive assembly includes a motor that is electrically connected to the electric energy source. The motor converts electric energy into a rotating force. The sliding door drive assembly also includes a transmission operatively connected to the motor for transmitting the rotating force to an output shaft. A cable drum is fixedly secured to the output shaft and rotates with the output shaft. A cable drum housing covers the cable drum. First and second cables are wound about the cable drum in opposite directions. The first cable extends from the cable drum forward along a path to the sliding door. The second cable extends from the cable drum rearward along the path toward the sliding door. The sliding door drive assembly also includes support guides extending tangentially out from the cable drum to guide the first and second cables outwardly and away from the cable drum along a path minimizing frictional forces. A position sensor is fixedly secured to the cable drum housing adjacent to the cable drum to identify the rotational position of the cable drum.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a fragmentary, perspective view of an interior portion of a motor vehicle including a sliding door drive assembly;

FIG. 2 is a perspective view of the sliding door drive assembly including support guides;

FIG. 3 is a perspective view of the sliding door drive assembly with the support guides removed;

FIG. 4 is a cross-sectional side view of a portion of the sliding door drive assembly with the support guides removed; and

FIG. 5 is a cross-sectional view of a portion of the sliding door drive assembly.

### DETAILED DESCRIPTION OF THE PREFERRED EMBODIMENT

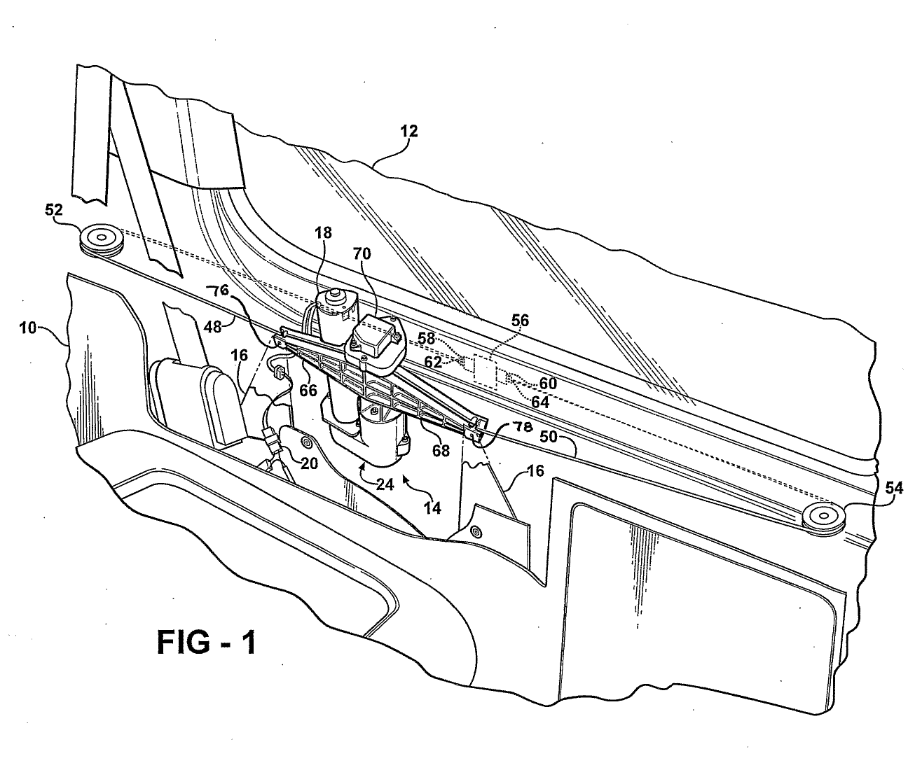

Referring to FIG. 1, a motor vehicle 10 is shown partially cutaway. The motor vehicle 10 includes a sliding door 12, also partially cutaway. A sliding door drive assembly, generally shown at 14, is mounted to the motor vehicle 10 and is operatively connected to the sliding door 12. Mounting brackets 16 mount the sliding door drive assembly 14 to the motor vehicle 10. It is appreciated that the mounting brackets may actually be another structure of the motor vehicle 10 having functions other than mounting the sliding door drive assembly 14 thereto.

The sliding door drive assembly 14 includes a motor 18 that is electrically connected to an electric energy source, graphically represented by an electric plug 20. It is contemplated that the motor 18 would operate using electric energy that is standard in a motor vehicle protocol. The motor 18 is bi-directional allowing for rotation of an output shaft 22 (FIG. 3) in two directions. The output shaft 22 is shown as the output shaft of a transmission, generally indicated at 24.

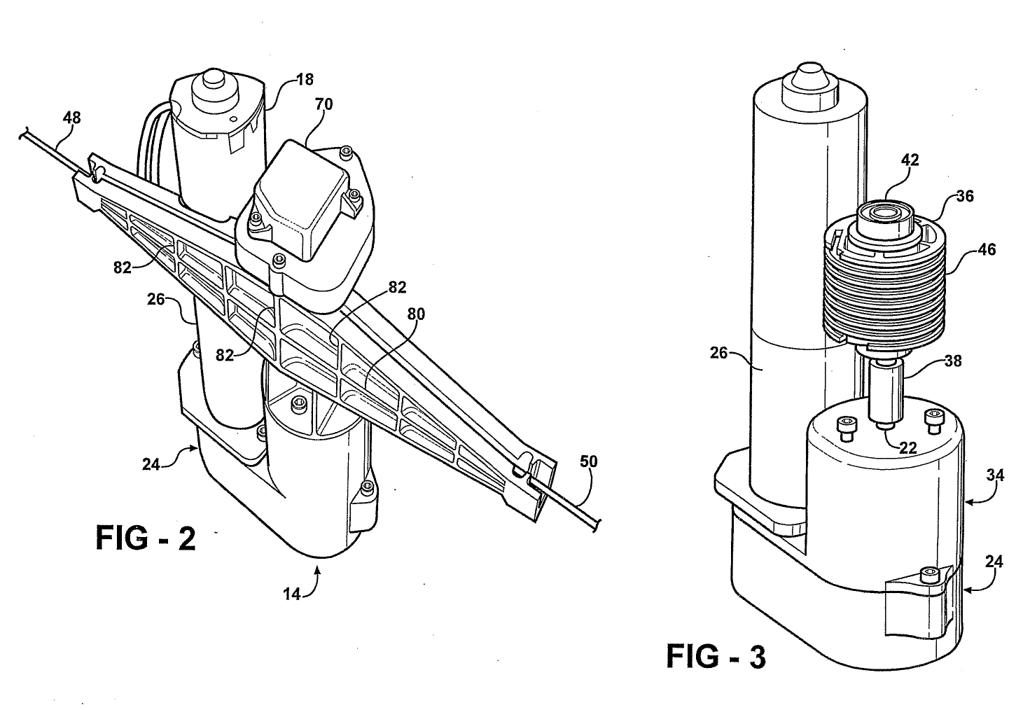

Referring to FIGS. 2 through 4, the transmission 24 is operatively connected to the motor 18 and transmits the rotating force of the motor 18 to the output shaft 22. The transmission 24 includes a gear set 26 inline with the motor 18 and used to provide the necessary mechanical advantage to translate the rotational output of the motor 18 into something suitable for the sliding door drive assembly 14 so that the sliding door 12 is able to move between a fully open position and a fully close position. The transmission 24 includes two toothed belt pulleys 28, 30 and a toothed belt 32 extending thereabout. One of the belt pulleys 28 rotates with the gear set 26 about a first axis. The other belt pulley 30 rotates about with the output shaft about a second axis. The second axis is different from the first axis. The toothed belt pulleys 28, 30 are used to change the direction of the rotational output of the motor 18. This facilitates the compact packaging of the sliding door drive assembly 14 by having the rotational force turned back to a position that minimizes the length requirement of the sliding door drive assembly 14. The toothed belt 32 is used to dampen vibrations extending between the electric motor 18 and the sliding door 12.

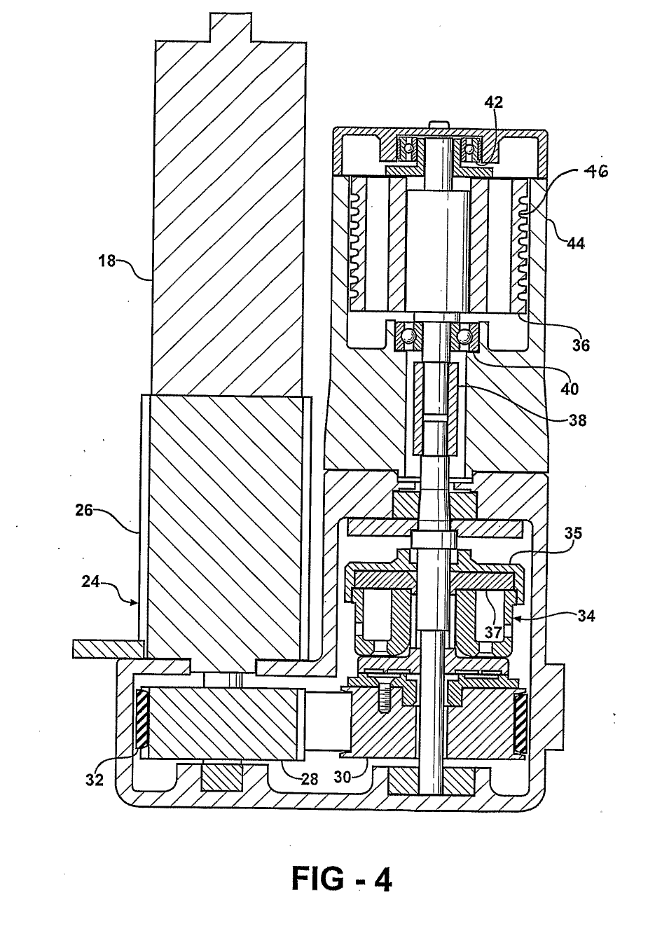

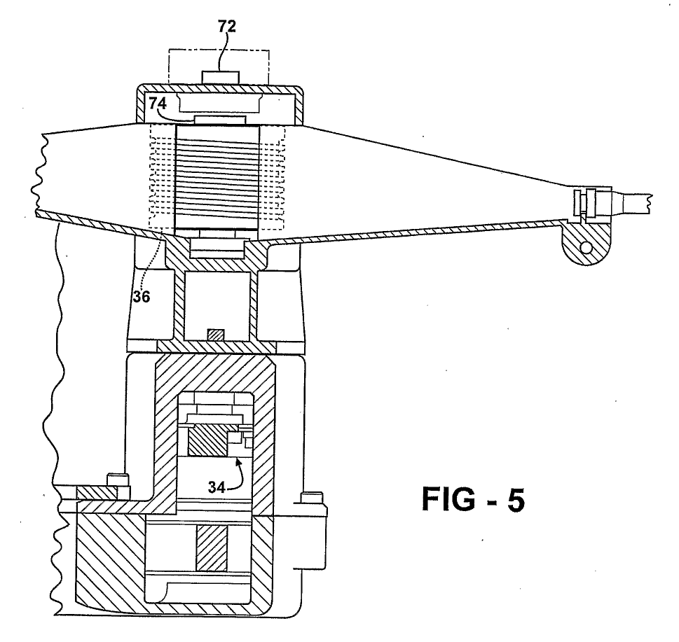

Referring to FIG. 4, the transmission 24 also includes a clutch, generally indicated at 34. The clutch 34 allows the sliding door 12 to be disengaged from the motor 18. The clutch 34 reduces the effort required to manually move the sliding door 12 should such manual movement be desired as opposed to having the sliding door drive assembly 14 operate the sliding door 12 between its fully open and fully close positions. The clutch 34 includes a pair of toothed plates 35, 37. The toothed plates 35, 37 are used to minimize the space required by the clutch 34. More specifically, the clutch 34 has a reduced diameter due to the fact that the plates 35, 37 utilized by the clutch 34 are toothed.

The sliding door drive assembly 14 includes a cable drum 36 that is coupled to the clutch 34 with a coupling 38. The cable drum 36 is held in place by two sets of bearings 40, 42 that are fixedly secured to a cable drum housing 44. The cable drum 36 includes a helical groove 46 about which first 48 and second 50 cables are wound. The first 48 and second 50 cables are wound about the cable drum 36 in the helical groove 46 in opposite directions. The first cable 48 extends from the cable drum 36 forward to a forwardly positioned pulley 52 whereafter the first cable 48 is redirected back toward the sliding door 12. The second cable 50 is redirected by a rearwardly positioned pulley 54 whereafter the second cable 50 is redirected back toward the sliding door 12. The first 48 and second 50 cables are each fixedly secured to a center hinge 56, which is fixedly secured to the sliding door 12. Rotation of the cable drum 36 winds one of the first 48 and second 50 cables and, at the same time, pays out the other of the first 48 and second 50 cables.

The center hinge 56 includes forward 58 and rearward 60 cable terminals for securing the first 48 and second 50 cables thereto, respectively. The forward 58 and rearward 60 cable terminals include respective forward 62 and rearward 64 cable tensioners. The forward 62 and rearward 64 cable tensioners tension the respective first 48 and second 50 cables.

The cable drum housing 44 includes support guides 66, 68 that extend out from the cable drum 36 and the cable drum housing 44 tangentially to the cable drum 36. The support guides 66, 68 guide the first 48 and second 50 cables outwardly and away from the cable drum 36 along a path that minimizes frictional forces. The support guides 66, 68 define a path for the first and second cables 48, 50 that minimizes frictional forces by minimizing the number of pulleys that would be required to redirect the path of the cable. This reduces parts as well as the frictional forces required to overcome the sliding door drive assembly 14.

The support guides 66, 68 also include mounting apertures 76, 78 that are used to have the sliding door assembly 14 mounted to the motor vehicle 10 with the mounting bracket 16. The support guides 66, 68 provide structural support for the sliding door drive assembly 14 and support the sliding door drive assembly 14 with all its integral parts. The support guides 66, 68 include reinforced ribs 80, 82 to provide additional rigidity to the sliding door drive assembly 14.

A position sensor 70 is mounted to the cable drum housing 44 for identifying the rotational position of the cable drum 36. The position sensor 70 is a very high resolution position sensor and includes a sensor 72 that senses the orientation of a magnet 74, which is fixedly secured to the cable drum 36 and rotates therewith.

The invention has been described in an illustrative manner. It is to be understood that the terminology, which has been used, is intended to be in the nature of words of description rather than of limitation. Many modifications and variations of the invention are possible in light of the above teachings. Therefore, within the scope of the appended claims, the invention may be practiced other than as specifically described.

What is claimed:

1. A sliding door drive assembly for a motor vehicle with an electric energy source and a sliding door, said sliding door drive assembly comprising:
a motor electrically connected to the electric energy source, said motor converting electric energy into a rotating force;
a transmission operatively connected to said motor for transmitting said rotating force to an output shaft;
a cable drum fixedly secured to said output shaft for rotating with said output shaft;
first and second cables wound about said cable drum in opposite directions, said first cable extending from said cable drum forward along the sliding door, said second cable extending from said cable drum rearward along the sliding door; and
support guides extending tangentially out from said cable drum to guide said first and second cables outwardly and away from said cable drum along a path minimizing frictional forces.

2. A sliding door drive assembly as set forth in claim 1 including a center hinge fixedly secured to the sliding door.

3. A sliding door drive assembly as set forth in claim 2 wherein said center hinge includes forward and rearward cable terminals secured to said first and second cables respectively.

4. A sliding door drive assembly as set forth in claim 3 including forward and rearward cable tensioners mounted to said center hinge for tensioning said first and second cables respectively.

5. A sliding door drive assembly as set forth in claim 1 wherein said transmission includes a gear set inline with said motor.

6. A sliding door drive assembly as set forth in claim 5 wherein said transmission includes a clutch for allowing selective manual movement of the sliding door.

7. A sliding door drive assembly as set forth in claim 6 wherein said clutch includes a pair of toothed plates.

8. A sliding door drive assembly as set forth in claim 7 wherein said transmission includes a belt between said gear set and said clutch.

9. A sliding door drive assembly as set forth in claim 8 including a cable drum housing covering said cable drum.

10. A sliding door drive assembly as set forth in claim 9 including a position sensor fixedly secured to said cable drum housing adjacent to said cable drum to identify the rotational position of said cable drum.

11. A sliding door drive assembly as set forth in claim 10 including a magnet coupled to said cable drum and sensed by said position sensor.

12. A sliding door assembly as set forth in claim 1 wherein at least one of said support guides includes reinforced ribs.

13. A sliding door drive assembly for a motor vehicle with an electric energy source and a sliding door, said sliding door drive assembly comprising:
a motor electrically connected to the electric energy source, said motor converting electric energy into a rotating force;
a transmission operatively connected to said motor for transmitting said rotating force to an output shaft;
a cable drum fixedly secured to said output shaft for rotating with said output shaft;
a cable drum housing covering said cable drum;
first and second cables wound about said cable drum in opposite directions, said first cable extending from said cable drum forward along the sliding door, said second cable extending from said cable drum rearward along the sliding door;
support guides extending tangentially out from said cable drum to guide said first and second cables outwardly and away from said cable drum along a path minimizing frictional forces; and
a position sensor fixedly secured to said cable drum housing adjacent to said cable drum to identify the rotational position of said cable drum.

14. A sliding door drive assembly as set forth in claim 13 wherein said position sensor is a high resolution position sensor.

15. A sliding door drive assembly as set forth in claim 14 including a center hinge fixedly secured to the sliding door.

16. A sliding door drive assembly as set forth in claim 15 wherein said center hinge includes forward and rearward cable terminals secured to said first and second cables respectively.

17. A sliding door drive assembly as set forth in claim 16 including forward and rearward cable tensioners mounted to said center hinge for tensioning said first and second cables respectively.

18. A sliding door drive assembly as set forth in claim 13 wherein said transmission includes a gear set inline with said motor.

19. A sliding door drive assembly as set forth in claim 18 wherein said transmission includes a clutch for allowing selective manual movement of the sliding door.

20. A sliding door drive assembly as set forth in claim 19 wherein said clutch includes a pair of toothed plates.
